(19) United States
(12) Patent Application Publication
(10) Pub. No.: US 2019/0137617 A1
(43) Pub. Date: May 9, 2019

(54) LOCATION OF A TARGET BY A TRACKING VEHICLE

(71) Applicants: UNIVERSITÉ CLERMONT AUVERGNE, Clermont-Ferrand (FR); CENTRE NATIONAL DE LA RECHERCHE SCIENTIFIQUE, Paris (FR); INSTITUT NATIONAL DE RECHERCHE EN SCIENCES ET TECHNOLOGIES POUR L'ENVIRONNEMENTEL ET L'AGRICU, Antony (FR)

(72) Inventors: Roland CHAPUIS, Issoire (FR); Jean LANEURIT, Ceyrat (FR); Christophe DEBAIN, Saint-Saturnin (FR)

(21) Appl. No.: 16/078,775

(22) PCT Filed: Feb. 21, 2017
(86) PCT No.: PCT/FR2017/050381

§ 371 Date: Jan. 14, 2019

(30) Foreign Application Priority Data
Feb. 22, 2016 (FR) 1651429

(51) Int. Cl. G01S 13/72; G01S 13/93

(52) U.S. Cl. CPC G01S 13/723; H04W 4/029; G01S 13/931

(57) ABSTRACT

Some embodiments relate to a method for locating a mobile target for a tracking vehicle, including a first communication module in a first location on the tracking vehicle in order to determine a first distance measurement between the first location and the mobile target at a first time, and a second communication module at a second location on the tracking vehicle in order to determine a second distance measurement between the second location and the mobile target at a second time, and a processing module for determining a forecast of the movement of the tracking vehicle between the first and second times, and for determining a location of the mobile target relative to the tracking vehicle from the first and second distance measurements, taking into account the forecast, so as to compensate for the movement, between the first and second times.

### CROSS REFERENCE TO RELATED APPLICATIONS

This application is a national phase filing under 35 C.F.R. § 371 of and claims priority to PCT Patent Application No. PCT/FR2017/050381, filed on Feb. 21, 2017, which claims the priority benefit under 35 U.S.C. § 119 of French Patent Application No. 1651429, filed on Feb. 22, 2016, the contents of each of which are hereby incorporated in their entireties by reference.

### BACKGROUND

Some embodiments relate to the field of tracking vehicles and, more particularly, to a method and to a device allowing the precise localization of a mobile target that the tracking vehicle has to follow.

The field of tracking vehicles is growing rapidly and in very varied fields of application.

For example, the tracking vehicle may be a motorized caddy automatically following a golf player. Another example is a carrier vehicle following a worker on an industrial construction site or inside a factory, a workshop or a storage warehouse.

Another example relates to the agricultural field, in which one or more motorized agricultural vehicles automatically follow a farmer.

In some applications, the tracking vehicles may follow another vehicle.

One related art constraint for the tracking vehicles is to maintain a constant distance with the target being tracked (pedestrian or other vehicle) and to follow its path, in other words to be able to react to changes in speed and in direction.

Various mechanisms have been provided to enable this tracking. Generally speaking, this tracking cannot be done without locating the target to be tracked with respect to the tracking vehicle. This location may notably include the distance and an angle with respect to the direction of the tracking vehicle.

One related art technique is based on laser range-finders and/or cameras used either in the visible spectrum or in the infrared. A mechanism for shape recognition in the images acquired by the cameras and/or by the range-finder is then run in order to detect the target to be tracked and to estimate its relative position.

Such methods are however sensitive to external interference such as, notably, changes in weather conditions (rain, smoke, fog, snow, etc.), changes in lighting, variations in temperature (seriously interfering with the infrared cameras), dazzling effects, the presence of obstacles (that can interrupt the contact between the target and the sensors), etc.

Furthermore, even in the ideal case of a perfect sensing of the environment, it remains difficult to differentiate the target from the other objects present in the environment.

For example, if the target is a pedestrian, it is technically difficult to distinguish him/her from another pedestrian present in the scene being observed. The sensor the most capable of differentiating between two pedestrians is a camera operating in the visible spectrum, but this sensor is furthermore the most sensitive to the environmental conditions. It cannot for example operate at night or in poor lighting. Under these conditions, range-finders and infrared cameras provide a better performance, but they do not allow one pedestrian to be easily distinguished from another. The range-finder does not allow silhouettes to be determined “in depth” and can only distinguish silhouettes on their physique or their size.

Furthermore, the target to be tracked may be temporarily obscured by an obstacle (tree, corner of a street, other pedestrian, etc.). The target can then no longer be located.

Other mechanisms are based on radio or ultrasound links. It is for example the case of those exposed in the U.S. Pat. No. 5,810,105 or in the application EP 2,590,041.

The localization is provided by two communications modules on the tracking vehicle and one module on the target. Based on measurements of the time of flight of the information exchanged between the module on the target and each of the modules on the tracking vehicle, a relative location may be estimated by trilateration.

However, these mechanisms provide an insufficient precision for the location. Indeed, if the radio connection is interrupted between the communications modules, in the same way as with the solutions based on cameras or range-finders, the determination of the location cannot be carried out.

Furthermore, even without such an interruption, the precision is greatly impacted by the absence of synchronization between the two communications streams: the first between the module of the pedestrian and the first module of the vehicle and the second between the module of the pedestrian and the second module of the vehicle. However, as observed by the Applicant, between the communications with the first and with the second module carried on board the tracking vehicle, the latter was able to move, such that a bias is inserted into the calculations of the trilateration. The location thus obtained therefore lacks precision and may even end up, in certain situations, with significant aberrations.

### SUMMARY

Some embodiments address or overcome, at least partially, the aforementioned drawbacks.

For this purpose, some embodiments are directed to a method for locating a mobile target by a tracking vehicle, including the determination of at least a first measurement of distance between the mobile target and a first location on the tracking vehicle, taken at a first time, and of a second measurement of distance between the mobile target and a second location on the tracking vehicle, taken at a second time, wherein the method determines a prediction of the movement of the tracking vehicle between the first and second times, and determines a location of the mobile target with respect to the tracking vehicle based on the first and second measurements of distance, taking into account the prediction, in such a manner as to compensate for the movement between the first and second times.

Some embodiments include one or more of the following features which may be used separately or in partial combination with one another or in full combination with one another: the prediction and the localization are determined by a Kalman filter, the prediction of the movement is determined based on a linear speed measurement and on the orientation of the steering carriage of the tracking vehicle, the prediction equations of the Kalman filter, between a time k and a time k−1 are

$${X}_{k / k - 1} = {R ( {Δ}_{θ} )}^{T} ( {X}_{k - 1 / k - 1} - ( \begin{matrix}- {Δ}_{D} sin ( {Δ}_{θ} / 2 ) \\ {Δ}_{D} cos ( {Δ}_{θ} / 2 )\end{matrix} ) )$$

$${P}_{k / k - 1} = {R ( {Δ}_{θ} )}^{T} ( {P}_{k - 1 / k - 1} + {G}_{k} {Q}_{u} {G}_{k}^{T} ) R ( {Δ}_{θ} ) + {Q}_{xy}$$

in which Qᵤ is the covariance matrix associated with the uncertainties in the proprioceptive information coming from the tracking vehicle, such that:

$${Q}_{u} = ( \begin{matrix}{σ}_{{v}_{r}}^{2} & 0 \\ 0 & {σ}_{{δ}_{r}}^{2}\end{matrix} )$$

$$and$$

$${G}_{k} = ( \begin{matrix}- {Δ}_{T} sin ( {Δ}_{θ} / 2 ) & - 0.5 {Δ}_{D} cos ( {Δ}_{θ} / 2 ) \\ {Δ}_{T} cos ( {Δ}_{θ} / 2 ) & - 0.5 {Δ}_{D} sin ( {Δ}_{θ} / 2 )\end{matrix} )$$

$$with$$

$${Δ}_{D} = {v}_{r , k} {Δ}_{T} , and$$

$${Δ}_{θ} = {v}_{r , k} \frac{{Δ}_{T} tan {δ}_{r , k}}{L}$$

Δ_{T} is the period of time between the times k and k−1.
v_{r,k} is the linear speed of the tracking vehicle at the time k;
δ_{r,k} is the orientation of the steering carriage of the tracking vehicle at the time k,
and,
L is the track-width of the tracking vehicle.
The method also includes: determining a control command aimed at adapting the speed and the direction of the tracking vehicle in order to steer it as a function of the location of the target n keeping at a setpoint distance.

Some embodiments are directed to a device for locating a mobile target for a tracking vehicle, including a first communications module at a first location on the tracking vehicle for determining a first measurement of distance between the first location and the mobile target at a first time, and a second communications module at a second location on the tracking vehicle for determining a second measurement of distance between the second location and the mobile target at a second time, and a processing module for determining a prediction of the movement of the tracking vehicle between the first and second times, and determining a location of the mobile target with respect to the tracking vehicle based on the first and second measurements of distance, taking into account the prediction, in such a manner as to compensate for the movement between the first and second times.

Some embodiments include one or more of the following features, which may be used separately or in partial combination with one another or in full combination with one another: the processing module determines the prediction of the movement of the tracking robot and the location of the target by a Kalman filter, the processing module determines the prediction of the movement based on proprioceptive measurements of the tracking vehicle.

Some embodiments are directed to a tracking vehicle including such a device.

Some embodiments are directed to a system including a tracking vehicle such as previously defined and a communications module equipping the mobile target.

Other features and advantages of some embodiments will become apparent upon reading the description of exemplary embodiments that follows, presented by way of example and with reference to the appended drawings.

### BRIEF DESCRIPTION OF THE DRAWINGS

FIG. 1 schematically shows one example of a context in which some embodiments may be applied.

FIG. 2 shows a schematic diagram of the principle of localization by trilateration.

FIGS. 3a, 3b, 3c schematically show various mechanisms for distance measurements.

### DETAILED DESCRIPTION OF EXEMPLARY EMBODIMENTS

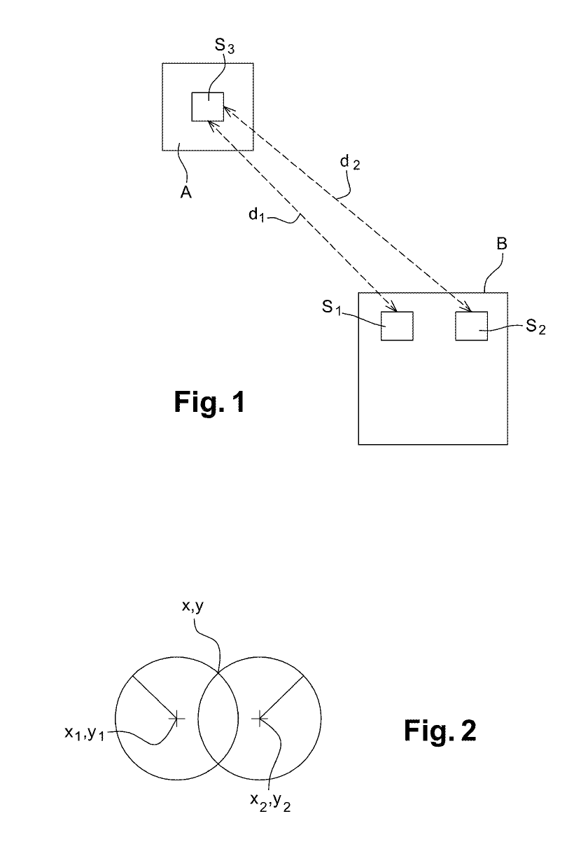

FIG. 1 illustrates schematically the context in which some embodiments may be applied.

Some embodiments allow a mobile target A to be located by a tracking vehicle B. The mobile target A is typically a human being, who may be a pedestrian, or a vehicle, including an automated vehicle. The tracking vehicle B may be an automated vehicle, in other words a vehicle driven by an automatic mechanism.

The mobile target A is equipped with a communications module S3. It will be seen hereinbelow that it may include more than one, but a single module is, generally speaking, sufficient for the implementation of some embodiments.

The tracking vehicle B is equipped with at least two communications modules S1, S2, situated at two separate locations on the vehicle. These two modules should be at a sufficient distance from each other in order to obtain the best possible or better localization results. They may for example be close to the two lateral sides of the tracking vehicle. They may be mutually rigidly installed, in other words their relative distance does not vary. They may be rigidly attached to the chassis of the tracking vehicle.

The communications modules S1, S2, S3 are intended to determine measurements of distance d1, d2, respectively between the module S1 and the module S3 and between the module S2 and the module S3.

These communications modules may notably be based on the standardized protocol IEEE 802.15.4a. This protocol is a standard specifying that the communications modules S1, S2, S3 incorporate a physical layer capable of performing measurements of distance. This protocol has two communication formats: the IRUWB (for “Impulse Radio Ultra Wide-Band”) and the CSSS (for “Chirp Spread Spectrum Signals”) formats.

A related art mechanism for measuring a distance can be used, but some embodiments are directed to the novel exploitation of these distance measurements. The measurement of distance may be carried out in various ways, including those used in the related art.

In the framework of the IEEE 802.15.4a protocol, the methods for measuring distance are based on the principle of measurement of the time of flight (or “Time of Arrival”) needed for a message to go from one communications module to another.

Thus, the “Time Of Arrival” (TOA) method, also referred to as “Time of Flight”, is a very simple method which allows the distance between a mobile station and a base station to be calculated.

For the generality of the description, in the following paragraphs, the expressions “mobile station” and “base station” are used, which may, in the framework of some embodiments, represent the tracking vehicle B and the target to be tracked A, respectively. It should be noted that the target may itself be mobile and that these terms “mobile station” and “base station” are to be understood in a relative sense: the mobile station is mobile in the frame of reference of the base station (whose frame of reference may itself be mobile with respect to the Earth's frame of reference for example).

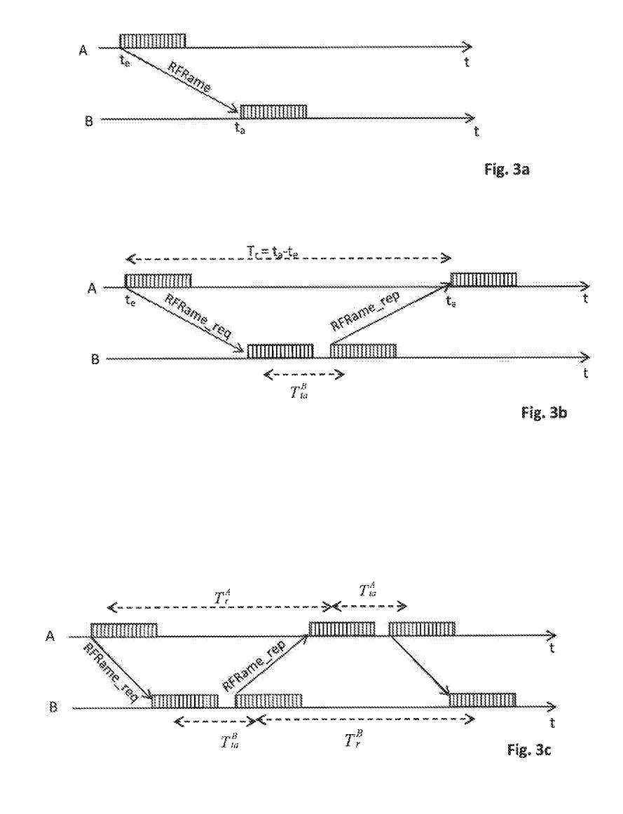

The mechanisms described are illustrated in FIGS. 3a, 3b, 3c, which schematically show the exchange protocols between two stations A, B, with a view to the measurement of distance between them.

The “Time Of Arrival” (TOA) method is illustrated in FIG. 3a.

The mobile station A sends a message RFRAME to the base station B at the date of transmission tₑ, this date being transmitted within the message. The base station receives the message and notes the date of acquisition tₐ.

The distance d separating the base station from the mobile station is then given by the expression

d=c·(tₑ−tₐ)

in which c is the speed of light. The main drawback is that the clocks of the two stations must or should be perfectly synchronized in order to obtain a very precise measurement. This may require an infrastructure that is very difficult to implement.

In order to overcome problems of synchronization of the clocks between the base stations and the mobile stations, the “Two Way Time Of Arrival” method has been developed. The latter is illustrated in FIG. 3b. It includes the following dialog between the base station and the mobile station: the base station A sends a request RFRrame_req to a mobile station B and records the date of transmission to of this message, the mobile station responds to the request by sending the message RFRrame_rep to the base station, the base station receives the response message and records the date of receipt tₐ. the base station A calculates the period of time during this exchange by the expression Tᵣ=tₑ−tₐ, and determines the distanced separating the base station from the mobile station by d=c·Tᵣ/2.

The base and mobile stations are therefore both transmitters and receivers. Since the time Tᵣ is measured by the base station A, there is no need to synchronize their clocks. Nevertheless, the response of the mobile station cannot be immediate. This is because it needs to decode the request message sent by the base station, and to create a response message and finally to send the latter. This process introduces a delay Tₜₐ^{B} and biases the distance measurement. For example, an error of a few nanoseconds introduces errors of the order of a decimeter. This delay should be estimated very precisely.

It is possible to use a more elaborate technique in order to obtain the estimation of Tₜₐ^{B} and hence to obtain a more precise measurement of the distance.

This time, the dialog between the base station and the mobile station is as follows: the base station A sends a request RFRrame_req to the mobile station B and records the date of transmission of the last byte of the SFD (“Start Frame Delimeter”) of the message RFRrame_req, the mobile station B responds to the request by sending the message RFRrame_rep to the base station and, in parallel, it launches a counter as soon as the last byte of the SFD of the message RFRrame_rep is read and stops it when the last byte of the SFD of the message RFRrame_rep is sent, the base station receives the reply message and records the date of receipt of the last byte of the SFD of the message RFRrame_rep, the mobile station sends a second message to the base station containing the value of the Tₜₐ^{B} estimated by the counter, the base station receives the message containing the estimation of the delay Tₜₐ^{B}, the base station sends an acknowledgement to the mobile station.

This time, it is possible to obtain a more precise measurement of distance by calculating:

$${d}_{TW} = c \frac{{T}_{r} - {T}_{ta}^{B}}{2}$$

A major source of error in the TW-TOA method is the shift in clock frequency between the base station and the mobile station. The onboard clocks in these modules use quartz crystals which do not operate at exactly the same frequency. Thus, delays or “advances” appear in the measurement of the time of arrival which, multiplied by the speed of light, can introduce significant errors into the measurement of the distance.

The “Symmetric Double Sides Two Way Time Of Arrival” (SDS-TW-ToA) method allows this problem to be solved. Such a technique is illustrated in FIG. 3c.

The idea is, this time, to also estimate the time Tₜₐ^{B} needed for the base station to decode the message RFRAMErep coming from the mobile station and to re-transmit a second message RFRAMEreq to the mobile station. Thus, the measurement of distance d_{SDS} is as follows:

$${d}_{SDS} = c \frac{( {T}_{r}^{A} - {T}_{ta}^{A} ) + ( {T}_{r}^{B} - {T}_{ta}^{B} )}{4}$$

In order to demonstrate the benefit of this method, the errors in frequencies e_{A} and e_{B} of the clocks on board the base station and the mobile station are defined, such that:

$${e}_{A} = \frac{{Rf}_{A} - {Nf}_{A}}{{Nf}_{A}}$$

$${e}_{B} = \frac{{Rf}_{B} - {Nf}_{B}}{{Nf}_{B}}$$

where Rf_{A} and Nf_{B} respectively represent the real and nominal frequencies of each of the clocks. By introducing them into the previous equations, the following is obtained:

$$\{ \begin{matrix}{\hat{d}}_{TW} = & c \frac{{T}_{r}^{A} ( 1 + {e}_{A} ) - {T}_{ta}^{B} ( 1 + {e}_{B} )}{2} \\ {\hat{d}}_{SDS} = & c \frac{( {T}_{r}^{A} - {T}_{ta}^{A} ) ( 1 + {e}_{A} ) + ( {T}_{r}^{B} - {T}_{ta}^{B} ) ( 1 + {e}_{B} )}{4}\end{matrix}$$

In the framework of the tracking of a pedestrian, the distance measurement is a few tens of meters at the most, so Tᵣ will not exceed 100 nanoseconds. On the other hand, the time Tₜₐ needed to process the request message and to respond to it is of the order of a millisecond. This means that the transmission time is much shorter than the time for processing the data which represents the major part of the error on the distance measurement:

$$\{ \begin{matrix}{\hat{d}}_{TW} = & c \frac{{T}_{r}^{A} ( 1 + {e}_{A} ) - {T}_{ta}^{B} ( 1 + {e}_{B} )}{2} \\ {\hat{d}}_{SDS} = & c \frac{( {T}_{r}^{A} - {T}_{ta}^{A} ) ( 1 + {e}_{A} ) + ( {T}_{r}^{B} - {T}_{ta}^{B} ) ( 1 + {e}_{B} )}{4}\end{matrix}$$

It can accordingly be seen that the error due to the shift in frequency of the clocks is compensated with the SDS-TW-TOA method if

Tₜₐ^{B}>>(Tₜₐ^{A}−Tₜₐ^{B})

According to some embodiments, the communications modules S1, S2, S3 may implement such mechanisms for measurement of distance. In practice, these mechanisms can be implemented by communications modules available in the market and that the method and the device according to some embodiments can use.

Such modules available in the market may notably be those from the company Decawave, and more particularly, the sensor DW1000. This sensor conforms to the aforementioned communications protocol IEEE 802.15.4a and operates within a frequency range from 3.5 GHz to 6.5 GHz with a bandwidth of 1 GHz. It enables the measurement of distance with a precision of 10 cm. This sensor offers, amongst others, the advantages of having a relatively low cost and of having a small size, for example 23 mm×13 mm for the model DWM1000.

FIG. 2 is a schematic diagram showing the principle of localization by trilateration.

The problem that needs to be solved is to locate the communications module S3 with coordinates (x, y) knowing the locations of the communications modules S1 and S2, with respective coordinates (x1, y1) and (x2, y2) and the distances d1, d2 measured between the communications module S3 and, respectively, the communications modules S1 and S2.

The position of the module S3 being the point of intersection between two circles centered on each of the modules S1, S2 and with radii d₁ and d₂, this problem may be very easily solved analytically.

By posing:

(d₁)²=(x−x₁)²+(y−y1)²=x²±y²

and

(d₂)²=(x−x₂)²+y²

the position of the module S3 with respect to that of the module S1 is then:

$$x = \frac{{( {d}_{1} )}^{2} - {( {d}_{2} )}^{2} - {( {x}_{2} )}^{2}}{2 {x}_{2}}$$

$$and$$

$$y = \pm \sqrt{{( {d}_{1} )}^{2} - {( x )}^{2}}$$

The position of the module S3 in the frame of reference of the “world” being:

x=x+x₁

y=y+y₁

There are of course two solutions to this problem; the sign of the ordinate y must or should be determined either by a constraint of the user or by adding a third communications module onto the tracking vehicle.

Thus, theoretically, it is possible to estimate the location of the communications module S3 under any circumstances.

However, in practice, because of measurement noise, it turns out that, under certain circumstances, there is no intersection between the two circles and hence no solution to the localization problem.

Furthermore, the measurement noise introduces very significant discontinuities over time. Indeed, the measurement noise introduces significant variations in the localization results, especially on the measurement of the heading. These variations are abrupt, hence the discontinuities, but the notion of discontinuity may be omitted. To give one example, in the framework of experiments carried out by the applicant, when the vehicles are static, the estimation of the heading can vary by plus or minus 5° from one measurement to the other because of the measurement noise on the distances. The Kalman filter implemented by one embodiment allows this problem to be attenuated while providing an original solution to the problems of synchronization.

Furthermore, and above all, the measurements of distance d1, d2 are not supplied synchronously, whereas the mechanisms described hereinabove assume a synchronization of the measurements. As will be seen hereinbelow, this phenomenon amplifies even more the errors on the estimation of the heading.

Generally speaking, it is difficult to provide a synchronization of the stream of messages transmitting the distance measurements, but furthermore the communications module S3 generally disposes of a communications interface allowing it to dialog alternately with the communications modules S1, S2. In other words, the measurements of distance d1, d2 are non-synchronized.

For example, the module S3 of the mobile target dialogs with a first module S1 of the tracking vehicle for a certain period of time, for example 5 ms. A measurement frequency may furthermore be fixed at 50 Hz. In such a situation, the measurements are spaced out by at least 20 ms.

However, the tracking vehicle is mobile and, as a result, between the time t1 at which the measurement of distance d1 is determined and the time t2 at which the measurement of distance d2 is determined, it will move by a distance determined by the speed of the vehicle, by its direction and by the inter-measurement period.

Consequently, the measurements of distance d1 and d2 do not correspond to the same position of the tracking vehicle and the trilateration methods cannot operate in a satisfactory manner.

The method according to some embodiments includes steps for determination of at least a first measurement of distance d1 between the mobile target A and a first location in (or on) the tracking vehicle B, typically corresponding to a first communications module S1, taken at a first time t1, determination of a second measurement of distance d2 between the mobile target A and a second location S2 in (or on) the tracking vehicle B, typically corresponding to a second communications module S2, taken at a second time t2, determination of a prediction of the movement of the tracking vehicle between the first and second times, t1, t2, and determination of a location of the mobile target B with respect to the tracking vehicle A based on these first and second measurements of distance, d1, d2, taking into account the movement prediction, in such a manner as to compensate for the movement of the tracking vehicle between the first and second times.

The determination of the movement may typically be made based on the measurement of linear speed of the tracking vehicle and on the orientation of its steering carriage. These measurements are supplied by the mechanisms for controlling and monitoring the tracking vehicle, notably by the proprioceptive sensors carried on board the latter.

The sensors for measurements on the state of the vehicle itself are referred to as proprioceptive sensors or sensors of proprioception. This is in contrast to the sensors on the external information. One example of a proprioceptive sensor is a speed sensor. This term is commonly understood by those of ordinary skill in the art as referred to in the Wikipedia page dedicated to robotics: https://en.wikipedia.org/wiki/Autonomous_robot

Thus, by predicting the location of the tracking vehicle, the method according to some embodiments can take into account its estimated movement in order to compensate for it. The measurement data d1, d2 may then be used in a valid and precise manner despite their asynchronism. The same is of course true if more than two measurement data values are supplied.

Various methods may be used in order to take into account the asynchronism of the measurements of distances together with the precision of the data d1 and d2. These methods make use of filtering techniques whose characteristics allow the following to be integrated: the asynchronism of the data coming from marker points, the movement of the vehicle between the time t1 and t2, the uncertainty in movement of the vehicle between the times t1 and t2, the uncertainty associated with the measurements d1 and d2.

Amongst the most widespread filtering techniques, Kalman filters and particulate filters are often the most effective, but others would be perfectly applicable as long as they incorporate the aforementioned characteristics.

According to one embodiment, a Kalman filter is used to determine the movement prediction and the location of the mobile target with respect to the tracking vehicle. This Kalman filter allows the location to be inferred and filtered at any moment.

The state vector of the Kalman filter represents the parameters that it is desired to estimate. In the framework of some embodiments, the state vector Xₖ of the Kalman filter reflects the position (x,y) of the mobile target A at the time k such that

$${X}_{k} = ( \begin{matrix}{x}_{k} \\ {y}_{k}\end{matrix} )$$

By construction, the Kalman filter also estimates the precision of the estimation at any moment. The latter is represented by the covariance matrix Qₖ.

Given that the measurements of distance between the mobile target A and the tracking vehicle B are asynchronous, one after the other, each measurement d_{n,k} is compared with its prior measurement d_{n,k/k-1} and the location of the mobile target is updated as a function of their difference. At each new measurement of distance coming from the communications module Sₙ (with n=1 or n=2, in the case of two modules), the equation for updating the Kalman filter at the time k is the following:

d_{n,k}=d_{n,k/k-1}=\sqrt{(x_{k/k-1}−xₙ)²±(y_{k/k-1}−yⁿ)²}

in which xₙ and yₙ are the coordinates of the location of the positioning of the communications module Sₙ on the tracking vehicle.

The next update of the state is carried out by the related art equations of the Kalman filter:

K_{n,k}=P_{k/k-1}H_{n,k}^{T}(H_{n,k}P_{k/k-1}H_{n,k}^{T}+σ_{d}²)⁻¹

X_{k/k}=X_{k/k}+K_{n,k}(d_{n,k}−d_{n,k/k-1})

P_{k/k}=(I−K_{n,k}H_{n,k})P_{k/k-1}

in which α_{d} is the standard deviation of the distance measurements. The Jacobian of the observation function is described by:

$${H}_{n , k} = ( \frac{{x}_{k / k - 1}}{{d}_{n , k / k - 1}} \frac{{y}_{k / k - 1}}{{d}_{n , k / k - 1}} )$$

Experimentally, it can be shown that, under certain circumstances, the Kalman filter may consider locations with a negative ordinate to be more probable than those with a positive ordinate. In order to overcome this problem, an estimation with a constraint may be implemented, in order to impose that the ordinate of the solutions found is usually positive: y_{k/k-1}>yₙ, where yₙ is the ordinate of the modules S₁, S₂ of the tracking vehicle. This hypothesis implies that the frame of reference is chosen in such a manner that the two modules S₁, S₂ are situated on a straight line parallel to the x axis.

Numerous methods exist for applying such a constraint within a Kalman filter. By way of examples may be mentioned those presented in the articles “Kalman filtering with state constraints: a survey of linear and nonlinear algorithms” by D. Simon, in IET Control Theory and Applications, 1303-1318, 2010, and “Constrained Kalman filtering via density function truncation for turbofan engine health estimation” by Dan Simon and Donald L. Simon, in Int. J. Systems Science, 41(2), 159-171, 2010.

In order to use the technology of Kalman filters to locate the target with respect to the tracking vehicle, the following new variables must or should be defined:

(xᵣ^{w}, yᵣ^{w}) is the location of the tracking vehicle in the frame of reference of the world;

θᵣ^{w} is the orientation of the tracking vehicle in the frame of reference of the world;

(xₚ^{w}, yₚ^{w}) is the location of the target in the frame of reference of the world;

(xₚ^{r}, yₚ^{r}) is the location of the target in the frame of reference of the tracking vehicle. This frame of reference may be defined to be centered on the middle of the rear axle of the vehicle, for example.

The kinetic model of the tracking vehicle then needs to be defined. One example of such a kinetic model may be:

$$\{ \begin{matrix}= {v}_{r} cos θ \\ = {v}_{r} sin θ \\ = {v}_{r} \frac{tan {δ}_{r}}{L}\end{matrix}$$

in which

yᵣ is the linear speed of the tracking vehicle;

δᵣ is the orientation of the steering carriage, and

L is the track-width of the tracking vehicle.

The term “track-width” refers to the distance between the right and left wheels on the same axle.

It is then possible to define the simple dynamic model, known as the Ackermann model:

$$\{ \begin{matrix}{x}_{r , k + 1}^{w} = {x}_{r , k}^{w} - {Δ}_{D} sin ( {θ}_{r , k}^{w} + {Δ}_{θ} / 2 ) \\ {y}_{r , k + 1}^{w} = {y}_{r , k + 1}^{w} - {Δ}_{D} cos ( {θ}_{r , k}^{w} + {Δ}_{θ} / 2 ) \\ {θ}_{r , k + 1}^{w} = {θ}_{r , k}^{w} + {Δ}_{D} \end{matrix}$$

in which

$${Δ}_{D} = {v}_{r , k} {Δ}_{T} , and {Δ}_{θ} = {v}_{r , k} \frac{{Δ}_{T} tan {δ}_{r , k}}{L}$$

Δ_{T} is the period of time between the times k and k−1, in other words the sampling period.

The equations hereinabove describe the movement of the tracking vehicle within the world. However, the problem here is to know the movement of the target in the frame of reference of the tracking vehicle.

The location of the target in the frame of reference of the tracking vehicle at the time k is defined as (xₚ^{r}, yₚ^{r})ₖ. It is assumed for the moment that the target is immobile. At the time k+1, the location of the target in the frame of reference of the tracking vehicle is given by the following equations:

$$( \begin{matrix}{x}_{p , k + 1}^{r} \\ {y}_{p , k + 1}^{r}\end{matrix} ) = {R ( {Δ}_{θ} )}^{T} ( \begin{matrix}{x}_{p , k}^{r} - ( {x}_{r , k + 1}^{w} - {x}_{r , k}^{w} ) \\ {y}_{p , k}^{r} - ( {y}_{r , k + 1}^{w} - {y}_{r , k}^{w} )\end{matrix} )$$

Using the preceding system of equations, the following is obtained:

$$( \begin{matrix}{x}_{p , k + 1}^{r} \\ {y}_{p , k + 1}^{r}\end{matrix} ) = {R ( {Δ}_{θ} )}^{T} ( \begin{matrix}{x}_{p , k}^{r} + {Δ}_{D} sin ( {Δ}_{θ} / 2 ) \\ {y}_{p , k}^{r} - {Δ}_{D} cos ( {Δ}_{θ} / 2 )\end{matrix} )$$

where R(Δ_{θ}) is a 2D rotational matrix, which is a function of the angle Δ_{θ}.

However, of course, the target may be mobile and, between two times, it can move in the frame of reference of the world.

The following may be written:

$$\{ \begin{matrix}= = 0 \\ = = 0\end{matrix}$$

and it may be injected into the preceding equation in order to obtain the equation describing the location of a mobile target with respect to a tracking vehicle:

$$( \begin{matrix}{x}_{p , k + 1}^{r} \\ {y}_{p , k + 1}^{r}\end{matrix} ) = {R ( {Δ}_{θ} )}^{T} ( \begin{matrix}{x}_{p , k}^{r} + {Δ}_{D} sin ( {Δ}_{θ} / 2 ) \\ {y}_{p , k}^{r} - {Δ}_{D} cos ( {Δ}_{θ} / 2 )\end{matrix} ) + {v}_{xy}$$

in which v_{xy} follows a two-dimensional centered normal law N(0,Q_{xy}) whose covariance matrix Q_{xy} is defined by the equation

Q_{xy}=I(σ_{xy}^{r}·Δ_{T})²

with σ_{xy}^{r} the standard deviation of the movement that can be made by the target in one second, and Δ_{T} the period of time (in seconds) between the times k and k+1.

Considering now that the location frame of reference is that of the tracking vehicle, it may be defined that the location (xₚ^{r}, yₚ^{r}) is equivalent to the location (x,y) previously used.

It is then possible to estimate the location of the target by the Kalman filter with constraints using the equation hereinabove.

The prediction equations of the Kalman filter thus defined become:

$${X}_{k / k - 1} = {R ( {Δ}_{θ} )}^{T} ( {X}_{k - 1 / k - 1} - ( \begin{matrix}- {Δ}_{D} sin ( {Δ}_{θ} / 2 ) \\ {Δ}_{D} cos ( {Δ}_{θ} / 2 )\end{matrix} ) )$$

$${P}_{k / k - 1} = {R ( {Δ}_{θ} )}^{T} ( {P}_{k - 1 / k - 1} + {G}_{k} {Q}_{u} {G}_{k}^{T} ) R ( {Δ}_{θ} ) + {Q}_{xy}$$

where Qᵤ is the covariance matrix associated with the uncertainties in the proprioceptive information coming from the tracking vehicle, such that:

$${Q}_{u} = ( \begin{matrix}{σ}_{{v}_{r}}^{2} & 0 \\ 0 & {σ}_{{δ}_{r}}^{2}\end{matrix} ) and$$

$${G}_{k} = ( \begin{matrix}- {Δ}_{T} sin ( {Δ}_{θ} / 2 ) & - 0.5 {Δ}_{D} cos ( {Δ}_{θ} / 2 ) \\ {Δ}_{T} cos ( {Δ}_{θ} / 2 ) & - 0.5 {Δ}_{D} sin ( {Δ}_{θ} / 2 )\end{matrix} )$$

with σᵥ_{ᵣ}² and σ_{δ}_{ᵣ}² given by the characteristics of the odometric sensors of the vehicle. These quantities are therefore to be determined for each vehicle.

Knowing the location of the target with respect to which the vehicle must or should be closed-loop controlled, it is possible to determine a control command aimed at adapting the speed and the direction of the tracking vehicle. It is furthermore possible to impose a setpoint distance between the tracking vehicle and the target.

Various mechanisms are possible for exploiting the location of the target determined by the method according to some embodiments, and allowing given behaviors of the tracking vehicle to be defined.

According to one particular embodiment, a control command is determined in order for the tracking vehicle to be directed toward the target while at the same time complying with a inter-distance setpoint ρ_{c}.

In the case of a tracking vehicle having a steering carriage and a drive train, the control vector is composed of the speed at the center of the rear axle vᵣ and of the orientation of the steering carriage δᵣ. Considering the location (ρ, θ) of the target to be tracked in a system of polar coordinates such that:

$$\{ \begin{matrix}ρ = \sqrt{{x}^{2} + {y}^{2}} \\ θ = arc tan 2 ( y , x )\end{matrix}$$

The latter respectively describes the inter-distance measured between the tracking vehicle and the target, together with the orientation that the tracking vehicle must or should follow in order to go and place itself behind the target. In order for the vehicle to follow the target, the control vector must or should be found that ensures that both p tends toward ρ_{c} and that θ tends toward 0. The problem is generally treated separately. The heading of the tracking vehicle may be corrected by using a proportional corrector:

δ_{r,k}=Kp_{θ}θₖ

in which Kp_{θ} is the proportional gain of the corrector. The inter-distance between the vehicle B and the target A may be regulated by an integral-proportional corrector:

$${v}_{r , k} = {Kp}_{ρ} ( {ρ}_{k} - {ρ}_{c} ) + {Ki}_{ρ} {\sum }_{i = 0}^{k} ( {ρ}_{i} - {ρ}_{c} )$$

in which Kp_{ρ} and Ki_{ρ} are respectively the proportional and integral gains of the corrector. The equation δ_{r,k}=Kp_{θ}θₖ shows that, in order to correct the heading of the vehicle, it suffices to orient the wheels of the steering carriage of the vehicle toward the target. The preceding equation shows that an integral action may be necessary for regulating the linear speed of the vehicle in order for the inter-distance to be adhered to, in other words for the quantity ρₖ−ρ_{c} to tend toward 0.

It is noted that, if the target is coming toward the vehicle, the quantity ρₖ×ρ_{c} becomes negative and will cause the vehicle to reverse since the speed v_{r,k} will also become negative.

It may be desirable to prevent the vehicle from reversing, notably for reasons of safety. In this case, it is possible, according to one embodiment, to introduce the following constraint:

$${v}_{r , k} = \{ \begin{matrix}{Kp}_{ρ} ( {ρ}_{k} - {ρ}_{c} ) + {Ki}_{ρ} {\sum }_{i = 0}^{k} ( {ρ}_{i} - {ρ}_{c} ) , & if {ρ}_{k} > {ρ}_{c} - 3 {σ}_{ρ , k} \\ 0 , & or else\end{matrix}$$

where σ_{r,k} is the standard deviation of the distance measurement ρₖ separating the vehicle and the target such that:

σ_{ρ,k}²=JᵣₕₒPₖJᵣₕₒ^{T}

with

$${J}_{rho} = ( \frac{{x}_{k}}{{ρ}_{k}} \frac{{y}_{k}}{{ρ}_{k}} )$$

and Pₖ is the matrix supplied at the time k by the module for locating the target. This matrix may be deduced a posteriori or a priori depending on whether the control command is carried out at the same time as the update of the Kalman filter or otherwise.

The preceding description relates to an embodiment in which the tracking vehicle disposes has 2 communications modules S₁, S₂, but it is also possible to consider more than 2 communications modules.

It goes without saying that the presently disclosed subject matter is not limited to the examples and to the embodiment described and shown, but numerous variants are possible which are accessible to those of ordinary skill in the art.

1. A method for locating a mobile target by a tracking vehicle, comprising:
determining a first measurement of distance between the mobile target and a first location on the tracking vehicle, taken at a first time;
determining a second measurement of distance between the mobile target and a second location on the tracking vehicle, taken at a second time;
predicting movement of the tracking vehicle between the first and second times; and
determining a location of the mobile target with respect to the tracking vehicle based on the first and second measurements of distance, taking into account the prediction, in such a manner as to compensate for the movement between the first and second times.

2. The method according to claim 1, wherein the prediction and the location are determined by a Kalman filter.

3. The method according to claim 2, wherein the prediction of the movement is determined based on a linear speed measurement and on the orientation of a steering carriage of the tracking vehicle.

4. The method according to claim 3, wherein prediction equations of the Kalman filter, between a time k and a time k−1 are
$${X}_{k / k - 1} = {R ( {Δ}_{θ} )}^{T} ( {X}_{k - 1 / k - 1} - ( \begin{matrix}- {Δ}_{D} sin ( {Δ}_{θ} / 2 ) \\ {Δ}_{D} cos ( {Δ}_{θ} / 2 )\end{matrix} ) )$$
P_{k/k-1}=R(Δ_{θ})^{T}(P_{k-1/k-1}+GₖQᵤGₖ^{T})R(Δ_{θ})+Q_{xy}
wherein Qᵤ is a covariance matrix associated with uncertainties in the proprioceptive information coming from the tracking vehicle, such that:
$${Q}_{u} = ( \begin{matrix}{σ}_{{v}_{r}}^{2} & 0 \\ 0 & {σ}_{{δ}_{r}}^{2}\end{matrix} ) and$$
$${G}_{k} = ( \begin{matrix}- {Δ}_{T} sin ( {Δ}_{θ} / 2 ) & - 0.5 {Δ}_{D} cos ( {Δ}_{θ} / 2 ) \\ {Δ}_{T} cos ( {Δ}_{θ} / 2 ) & - 0.5 {Δ}_{D} sin ( {Δ}_{θ} / 2 )\end{matrix} )$$
with
$${Δ}_{D} = {v}_{r , k} {Δ}_{T} , and {Δ}_{θ} = {v}_{r , k} \frac{{Δ}_{T} tan {δ}_{r , k}}{L} .$$
Δ_{T} is the period of time between the times k and k−1;
v_{r,k} is the linear speed of the tracking vehicle at the time k;
δ_{r,k} is the orientation of the steering carriage of the tracking vehicle at the time k, and,
L is the track-width of the tracking vehicle.

5. The method according to claim 1, further comprising determining a control command aimed at adapting the speed and the steering of the tracking vehicle in order to direct it as a function of the location of the target while keeping at a setpoint distance.

6. A device for locating a mobile target for a tracking vehicle, comprising:
a first communications module at a first location on the tracking vehicle for determining a first measurement of distance between the first location and the mobile target at a first time;
a second communications module at a second location on the tracking vehicle for determining a second measurement of distance between the second location and the mobile target at a second time; and a processing module for determining a prediction of movement of the tracking vehicle between the first and second times, and determining a location of the mobile target with respect to the tracking vehicle based on the first and second measurements of distance, taking into account the prediction in such a manner as to compensate for the movement between the first and second times.

7. The locating device according to claim 6, wherein the processing module determines the prediction of the movement of the tracking robot and the location of the target by a Kalman filter.

8. The locating device according to claim 7, wherein the processing module determines the prediction of the movement based on proprioceptive measurements of the tracking vehicle.

9. A tracking vehicle, comprising:
the device according to claim 6.

10. A system, comprising:
the tracking vehicle according to claim 9; and a communications module equipping the mobile target.
